(19) United States
(12) Patent Application Publication
(10) Pub. No.: US 2005/0277430 A1
(43) Pub. Date: Dec. 15, 2005

(54) Intelligent mobile messaging and communication traffic Hub (iHub)

(76) Inventors: Armin Meisl, Muenchen (DE); Shailesh Lakhani, Mississauga (CA)

Correspondence Address: Armin Meisl, Radlkoferstrasse 11a, Muenchen, Bayern, D-81373, DE

(21) Appl. No.: 10/842,509

(22) Filed: May 11, 2004

(51) Int. Cl. H04Q 7/20

(52) U.S. Cl. 455/466

(57) ABSTRACT

The invention disclosed is designed to facilitate and enable text and/or multi-media messaging between multiple network elements such as ESMEs, SMSCs, MMSCs, or other such messaging elements.

### BACKGROUND ART

Existing elements of the art all exhibit common limiting elements and features, which often do not provide for non-obvious advances in the art. Consider the trinity of U.S. Patent Applications 20030003932 (by Corrigan et al., entitled messaging applications router), 20030101283 (by Lewis et al., entitled system for translation and communication of messaging protocols into a common protocol), and 20030109271 (by Lewis et al., entitled telecommunications system messaging infrastructure), which all do not disclose load sharing and routing technologies, normalization functionality, nor throttling mechanisms to buffer messaging traffic, as does our disclosure of present seeking the protection of Letters Patent. Indeed, the load sharing and routing technologies of our disclosure remain particularly advanced in light of the state of the art, as it allows EMSE partners (in this instance for the purposes of illustration) to bind transparently and utilize the SMPP v3.3, SMPP v3.4 primitives, and other iterations as the art evolves (this includes commands such as query_sm, replace_sm, and submit_sm (with replace) that other SMPP routing products often disallow). (Please note that the reliance upon short message network elements and Short Message Peer to Peer (SMPP) protocol) is to be construed as expressly for pedagogical purposes in helping elucidate the art as concisely and beneficially as practical).

Indeed, further advances not provided for in the existing art, include the articulated functionality to block unauthorized messaging traffic from entering a mobile network (filters providing operator configurable blacklist functionality provide the capability to bar unauthorized messages from entering and consuming valuable network resources, inter alia), and in alternate non-limiting embodiments, our invention provides an external MNP Database query support to retrieve the originating address, destination address, and routing destination information under MNP environment, and also supports an interface with real time billing platforms to ensure only messages which can be successfully billed are routed (if so desired).

### REFERENCES CITED

| | | | |
|---|---|---|---|
| U.S. Patent Application | January 2003 | Corrigan et al. | 455/466 |
| 20030003932 | | | |
| U.S. Patent Application | May 2003 | Lewis et al. | 709/246 |
| 20030101283 | | | |
| U.S. Patent Application | June 2003 | Lewis et al. | 455/517 |
| 20030109271 | | | |

### TECHNICAL FIELD

The present invention relates generally to wireless communications and gateway messaging services; and more specifically, to a method for implementing an Intelligent Mobile Messaging and Communication Traffic Hub (iHub).

### SUMMARY OF THE INVENTION

The invention provided herewith has been articulated to connect to network elements which ordinarily intermediate messaging traffic. The Intelligent Mobile Messaging and Communication Traffic Hub (iHub) serves as a central point of connectivity and management for messaging traffic. Short Message Service Centers (SMSCs), External Short Message Entities (ESMEs), Multimedia Messaging Service Centers (MMSCs) and other network messaging elements connect to the invention to provide sources and destinations for messages.

Internal to the logic of the invention, messaging traffic is throttled, queued and routed to the appropriate destination based on defined routing tables. Each message is routed individually on a several variables for maximum operator flexibility. Traffic may also be configured to be blocked and filtered, to prevent illicit use of network resources.

In alternate embodiments, the invention may be configured to create event records for each message that is transmitted using the invention. This allows the telecommunications network operator to account for and analyze traffic in a mobile network.

### BRIEF DESCRIPTION OF THE DRAWINGS

FIG. 1 illustrates a typical, non-limiting embodiment of the system level architecture employed in the disclosure of present.

FIG. 1A illustrates an alternate embodiment of the disclosure providing for bi-directional communication between any authenticated third party applications (including email transfer) to and from any mobile terminal (capable of supporting messaging technologies, as SMS (Short Message Service), MMS (Multi-media Message Service) and so on).

### DETAILED DESCRIPTION OF THE PREFERRED EMBODIMENTS

Members skilled in the art will recognize that the ensuing represents an illustrative recital of the preferred embodiments of the invention of present and other embodiments may be articulated, gleaned and articulated from such while still remaining with in its spirit and scope. Indeed, equivalents found within the state of the art, and those which may reasonably and effectively be deemed equivalent in the future should also be understood as being incorporated by reference hereto and such. Furthermore, much of the language has been illustrative (as for instance, the reliance upon short message network elements and Short Message Peer to Peer (SMPP) protocol) and is to be construed as expressly for pedagogical purposes in helping elucidate the art as concisely and beneficially as practical.

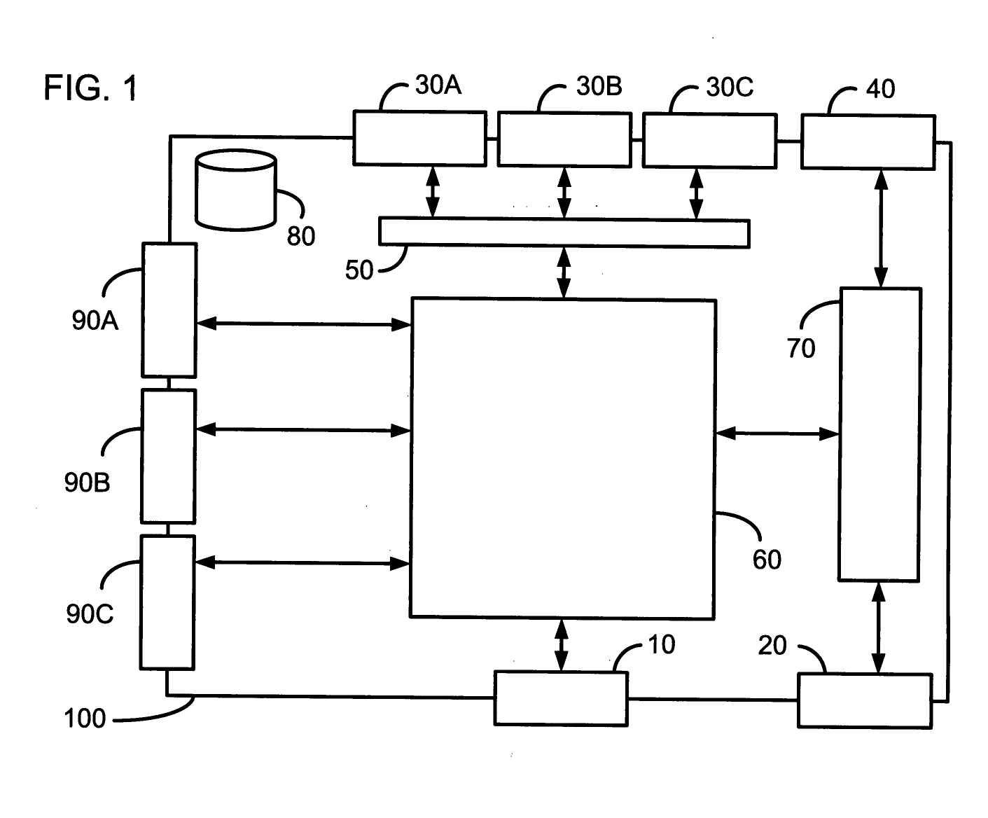

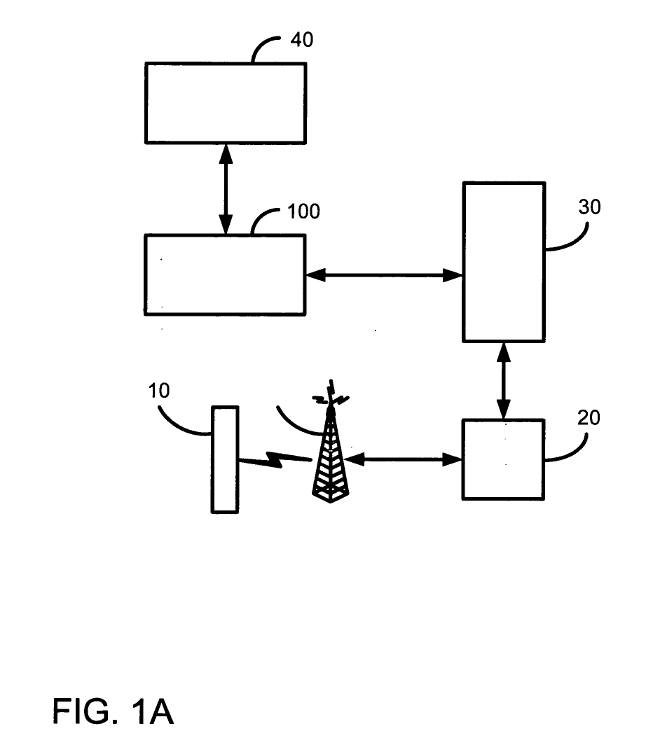

Disclosed as part of a computer program product the functionality of the invention, as depicted in FIG. 1, may be conceptually divided among an ESME Transmitter Manager 10 (which manages and maintains ESME transmitter connections), ESME Receiver Manager 20 (manages and maintains ESME receiver connections), SMSC Transmitter Manager 30A, 30B, 30C (manages and maintains SMSC transmitter connections from the invention 100 to SMSC(s)), SMSC Receiver Manager 40 (manages and maintains SMSC Receiver connections from the invention 100 to SMSC(s)), SMSC Transmitter Group Manager 50 (allows the definition of groups in SMSC Transmitter Connections to the SMSC), Transmitter Routing Engine 60 (allows for flexible routing of messages submitted over SMPP transmitter connections), and a Receiver Routing Engine 70 (allows for automatic routing of messages delivered over SMPP receiver connections). Other elements from FIG. 1, include internally articulated (and logically incorporated) logging and network management elements 80 (system logs, event records, and so forth) together with administrative interfaces 90A, 90B, 90C for web and XML-based configuration of the computer program product 100 (as commonly taught and practiced in the state of the art).

As before, much of the foregoing and ensuing remains quite short-message (SM)-centric (and enhanced SM-centric), and is purely for illustrative purposes as the open architecture nature of the invention of present may apply to messaging network elements in general (as multi-media, instant messaging, tactile ring tones/vibrations/pulses (for the visually impaired), and so forth).

Routing through the invention 100 has been provided for in both direction, SMSC (in this instance) to ESME and ESME to SMSC. Traffic in both directions is routed independently. As for ESME to SMSC routing, the Routing Engine definition allows the telecommunications carrier to determine the routing parameters that the invention is to employ when forwarding messages to SMSC(s). In the preferred embodiment, rules are considered in order. The first rule that matches a given SMS Event will be used and all other rules will be ignored. If no rules match, the message will be discarded. The telecommunications carrier (or other similar technician skilled in the art) can insert, change or delete rules as they please. Now for SMSC to ESME routing, (as suggested prior), the routing of messages from a SMSC to an ESME is independent from the routing of messages from an ESME to an SMSC. (The “Virtual Routing Table” contains all routing information for all connected ESME Receivers). When an EMSE logs in to the invention, routing entries are automatically added into the Virtual Routing Table. All messages that enter the invention from SMSC Receiver bind connections are routed to ESMEs using the Virtual Routing Table. The Virtual Routing Table contains all ESMEs connected to all nodes in the invention. ESMEs can bind to any node in the invention's cluster (if implemented as a cluster) and to receive messages from any connected SMSC Receiver connection

Continuing then with reference to FIG. 1, the ESME Transmitter Manager 10 is responsible for SMPP transmitter bind connections to the invention 100. ESME Transmitters connect to the invention 100 to submit messages to an operator's SMSC(s) (not shown). The invention 100 manages and controls ESME connections, providing throttling and connection management services that reduce network impact and consolidate SMPP data flows. Therefore the ESME Transmitter Manager 10, in advancing the art, provides certain connection management functionality(ies), as authenticating ESME requests, maintaining connection health with enquire links and throttling.

The ESME Transmitter Manager 10 manages and maintains the SMPP connection with the ESME partner (not shown). In the preferred embodiment, an ESME must be authenticated before being allowed to submit messages to the invention. Any messages from unauthenticated ESMEs are not acknowledged by the invention 100. (All ESMEs have to authenticate within a certain configurable time period).

In order to submit messages for delivery, the ESME partner must first establish a transmitter bind connection to the invention 100. Each ESME partner that connects to the invention must, in the first embodiment, be provisioned with an ESME profile. The ESME profile is defined via a GUI interface 90A, 90B, 90C.

The invention 100 then authenticates each ESME bind transmitter request. The following non-limited parameters are illustrative of those which may be verified before accepting the bind request:
1. System Type, System ID, Interface Version, and Password supplied in the bind transmitter request all must match (in the preferred embodiment) a provisioned ESME Transmitter Profile; and
2. In the preferred embodiment, ESME Transmitter Profile must be in a Enabled state; and
3. The number of bound in ESME Transmitters must be less than the configured “Maximum Number of Transmitter Connections” parameter in the ESME profile; and
4. A confirmation of when the number of transmitter connections is exceeded.

In maintaining the integrity and efficacy of the system, in the preferred embodiment if the request fails any of the above verification(s), the bind transmitter request is rejected with a configurable SMPP error code in a bind_transmitter_resp. Also configurably, a SNMP trap can be sent to the NMC. (These configuration parameters are stored in a text-based configuration file).

For each bind request from an ESME, an event record is created and optionally stored (whether permanently or transitorily) 80. If the ESME bind transmitter request is accepted, a bind_transmitter_resp message is returned to the ESME with a successful command status code. Subsequently, the ESME is permitted to submit SMPP messages to the invention 100.

In alternate embodiment, the invention 100 can (if enabled) maintain and ensure the status of a SMPP transmitter connection by sending enquire link messages to the ESME partner. The ESME partner is to respond with a enquire link response message, indicating the connection is available. If the ESME partner does not respond to a enquire link message, the logic of the invention 100 sends a unbind message to the ESME partner, and the connection is terminated. Incoming enquire link messages from the ESME are answered by the invention 100. An active connection is responded to with a successful command status value, and inactive connection is responded to with an unconnected command status value (as per the SMPP specification(s)).

The invention 100 throttles messages from ESME partners in order to prevent the excessive utilization of network elements by external entities. In an ESME Transmitter bind, only the numbers of messages defined by the throttling parameter (in messages/second or some other unit of measurement) configured in the ESME Transmitter profile are allowed. Subsequent messages are rejected with a configurable error code.

In still further alternate embodiments, when the Originating Address Verification has been articulated, the invention's 100 ESME Transmitter Manager 10 ensures that ESMEs only submit messages with provisioned Originating Addresses. This ensures that ESME partners submit only authorized messaging traffic to the mobile network. Valid originating addresses are stored in the ESME Transmitter profile 80. A full source address with TON, NPI, and MSISDN must be entered for each valid origination number. The TON and NPI fields are exact matching. The MSISDN by default is exact matching, with left matching allowed if “*” is the last character.

Continuing with the alternate embodiments, the invention 100 also normalizes the destination addresses to an international format for correct routing. Normalization functions are only provided in routing from the ESME to SMSC.

The data of the normalization is provided via a configurable table. For the purposes of illustration, this alternate functionality is provided for in two logical commands; “Add”; and “Replace”.

In advancing the art and utility of the invention's teleology, these two commands hide the complexity of the normalization to the wireless customer in question. The “Add” command follows the following logic: If prefix =='44178**, prepend ‘00’; Example: 44178, then 004178. The “Replace” command follows the following logic: If prefix =='0178**, Strip 1 character from left and prepend ‘44’; Example: 0178, then 44178.

Continuing with reference to FIG. 1, the EMSE transmitter manager 20, is responsible for SMPP receiver bind connections to the invention 100. ESME receivers connect to the invention 100 to receive messages from an operator's SMSC(s). The invention 100 manages and controls ESME connections, providing throttling and connection management services that reduce network impact and consolidate SMPP data flows. Therefore the ESME Receiver Manager 20 provides connection management functionality as authenticating ESME requests, and maintaining connection health with enquire links, inter alia.

The ESME Receiver Manager 20 manages and maintains the SMPP connection with the ESME partner. In maintaining the integrity and security of the art, an ESME must be authenticated before being allowed to receive messages to the invention. Any messages from unauthenticated ESMEs are not acknowledged by the invention 100.

In order to receive messages, the ESME partner must first establish a receiver bind connection to the invention 100. Each ESME partner that connects to the invention 100 must be provisioned with a an ESME profile 80. The ESME profile is defined via a GUI interface, or similar articulated and/or logical interface 90A, 90B, 90C.

The following non-limited parameters are illustrative of those which may be verified before accepting the bind request:
1. System Type, System ID, Interface Version, and Password supplied in the bind transmitter request all must match (in the preferred embodiment) a provisioned ESME Receiver Profile; and
2. In the preferred embodiment, ESME Transmitter Profile must be in a Enabled state; and
3. The number of bound in ESME Receivers must be less than the configured “Maximum Number of Transmitter Connections” parameter in the ESME profile; and
4. A confirmation of when the number of receiver connections is exceeded (as provisioned in the ESME profile).

If the request fails any of the above verification(s), the bind receiver request is rejected with a configurable SMPP error code. Also configurably in alternate embodiments, a SNMP trap can be sent to the NMC (These configuration parameters are stored in a text-based configuration file). Where the ESME bind transmitter request is accepted, the ESME is permitted to submit SMPP messages to the invention 100.

Following a SMPP receiver bind into the invention 100, messages can be routed to that ESME Receiver 20. Message routing to the EMSE Receiver 20 is controlled by a Virtual Routing table (logically incorporated and not shown). For ESME Receivers 20 that maintain multiple receiver connections to the invention, messages are load-shared across the connections on a per node basis. Messages are not routed internal to the invention 100, when one or more ESME Receivers 20 are connected to each node.

In alternate embodiments, where enabled, the invention 100 can maintain and ensure the status of a SMPP receiver connection by sending enquire link messages to the ESME partner. The ESME partner is to respond with a enquire link response message, indicating the connection is available. If the ESME partner does not respond to a enquire link message, the invention 100 sends a unbind message to the ESME partner, and the connection is terminated. (Incoming enquire link messages from the ESME are answered by the invention 100). An active connection is responded to with a successful command status value, and inactive connection is responded to with an unconnected command status value (as per the SMPP specification(s)).

The invention 100 in the preferred embodiment pro-offers a high performance in-memory message store. The number of messages that may be stored is a function of (and limited by) the hardware configuration of invention's 100 nodes, as taught by the state of the art. The invention 100 stores messages in the ESME Receiver Manager 20 module. Messages are stored in the invention 100 when throttling limitations to the ESME are exceeded, or the ESME is not bound into the invention 100. Upon the successful binding of the ESME associated with the interface, messages are delivered to the ESME according to the throttling parameters specified in the ESME Receiver Profile. In advancing the art, in the preferred embodiment, the ESME Receiver storage space is organized in circular queue. Messages are delivered to the ESME in a FIFO (first-in first-out) order (although in alternate embodiments, other alternatives are readily apparent). Should the message storage space be full, the invention 100 overwrites existing messages in the queue. In the preferred embodiment, the replacement policy is the oldest messages replaced first (although in alternate embodiments, other alternatives are readily apparent).

In advancing the art, the invention 100 throttles messages to ESME partners in order to prevent excessive impact on external entities. In an ESME Receiver bind, only the number of messages defined by the throttling parameter (in messages/second or some other unit of measurement)) configured in the ESME Receiver profile is allowed. Subsequent messages are either stored in the invention's in-memory message store (where configured), and/or, transitorily cached pending such configuration 80, and then, discarded after some configurable time period.

The ESME Receiver Manager 20 provides the capability of duplicating all SMPP delivery receipts received to the invention 100 and providing to an external system. This feature allows delivery receipts to be passed to a total of two external systems (the ESME and an alternative system).

Continuing with reference to FIG. 1, in order to enable load-sharing and fail-over SMPP routing, the invention's 100 SMSC Transmitter Group Manager 50 allows the network operator (or like skilled technician in the art) to define SMSC Transmitter Groups. These groupings can be used to combine SMPP transmitter links to larger groups for advanced routing functions like failover and load-sharing. SMSC Transmitters make up a SMSC Transmitter Group. The composition of the group is defined via the administration interface 90A (for instance).

Indeed, the SMSC Transmitter Manager(s) 30A 30B 30C, manage and maintain SMSC transmitter connections from the invention 100 to the SMSC(s). The SMSC Transmitter Manager(s) 30A 30B 30C are responsible for the invention's 100 transmitter bind connections to the SMSC(s). SMSC Transmitters connect to an network operator's SMSC(s) to submit messages from ESMEs. The invention 100 has been articulated to manage and control SMSC Transmitter connections, by, inter alia, providing throttling and connection management services which reduce network impact and consolidate SMPP data flows. Illustrative embodiments of the SMSC Transmitter Manager's(s') 30A 30B 30C connection management functionality include:
1. Establishing and maintaining connections. The SMSC Transmitter Manager(s) 30A 30B 30C manage and maintain the SMPP connection with SMSC(s). An SMPP link (in this instance) to an SMSC must be established before messages can be submitted to it. In alternate embodiments, where articulated and enabled, the invention 100 can maintain and ensure the status of a SMPP transmitter connection by sending enquire link messages to the connected SMSC. The connected SMSC is to respond with a enquire link response message, indicating the connection is available. Incoming enquire links will be answered with an enquire link response message. If the connected SMSC does not respond to a configurable number of successive enquire link messages, the invention 100 sends an unbind message to the connected SMSC, and the connection is terminated. (In further alternate embodiments, an SNMP trap can also generate when the connection to the SMSC is broken).

2. Sequence number altering. In advancing the art, the invention 100 alters sequence numbers of submitted messages to the connected SMSC.

Thereafter, the invention 100 stores submitted sequence numbers and their altered equivalent in an internal in-memory table. Thereby enabling the invention 100 to treat each message as an individual unit, and not keep a session open waiting for a response message from the SMSC. (Practitioners in the art will recognize that this improves performance substantially). Upon receipt of a response message from the SMSC, the invention 100 substitutes the correct sequence number and returns the response message to the ESME. The entry from the internal in-memory table may then optionally (but preferentially) be removed. In the preferred embodiment, Message IDs are not altered by the invention 100.

3. Throttling. In the event of an overload (throttling parameters exceeded) of a single transmitter link to a SMSC the SMSC Transmitter Manager(s) 30A 30B 30C will reject the message with a configurable error code. Also configurably, a SNMP trap can be sent to the NMC.

Still with reference to FIG. 1, the SMSC Receiver Manager 40 is responsible for the invention's 100 SMPP receiver bind connections to the SMSC(s). SMSC Receiver connections connect from the invention 100 to receive messages from a network operator's SMSC(s). The invention 100 manages and controls SMSC connections, providing connection management services that reduce network impact and consolidate SMPP data flows. The SMSC Receiver Manager 40 is therefore principally responsible for establishing and maintaining connections; and, maintaining connection health with ‘enquire’ links. Indeed, the SMSC

Receiver Manager 40 manages and maintains the SMPP receiver connections with the SMSC(s). An SMPP Receiver link to a SMSC must be established before messages can be received from it. The SMSC Receiver Manager 40 will accept all incoming deliver_sm from the SMSC. In alternate embodiments, where articulated, the invention 100 can maintain and ensure the status of a SMPP receiver connection by sending enquire link messages to the connected SMSC. The connected SMSC is to respond with a enquire link response message, indicating the connection is available. Incoming enquire links will be answered with an enquire link response message. If the connected SMSC does not respond to a enquire link message, the invention 100 sends a unbind message to the connected SMSC, and the connection is terminated. The invention 100 does not throttle incoming SMPP receiver links. Incoming messages are routed by the invention 100 and passed on to the ESME Receiver Manager 20. The ESME Receiver Manager 20, would then in the preferred embodiment, either deliver the message the ESME; or store the message for later delivery to the ESME; or discard the message.

With reference now to FIG. 1A, which is intended to provide for a non-limiting illustration of the flexibility and capability of the art of present seeking the protection of Letters Patent. The invention's 100 “Application Gateway” (not shown but logically incorporated into the computer program product 100) provides bi-directional communication between any authenticated third party application (including email transfer) to and from any mobile terminal (capable of supporting messaging technologies, as SMS (Short Message Service), MMS (Multi-media Message Service) and so on). The Application Gateway enables subscribers to interact with third party applications by entering a system configurable keyword (hard or soft coded), USSD short code, voice command, picture and/or MMS based authentication methods.

Consider the embodiment where the invention 100 interacts with third party CORBA/SOAP based applications. (Indeed, please note that much of the language herewith is purposefully illustrative (as for instance, the reliance upon short message network elements and Short Message Peer to Peer (SMPP) protocol) and is to be construed as expressly for pedagogical purposes in helping elucidate the art as concisely and beneficially as practical).

Any application developer (third party) can leverage the functionality of the invention 100 to build CORBA/SOAP based products and services. By using the Application Gateway, third party applications 40 can interact with mobile subscribers 10 on the carrier's network by knowing the subscriber's MSIDSN. Any authenticated third party service 40 can make application calls to the Application Gateway via a rich set of APIs. Subsequently the application call is converted into SMPP and forwarded to the invention 100 for more sophisticated routing and application management.

Conversely, where a subscriber 10 wishes to interact with a third party application 40 using a SMS (in this instance) enabled handset 10, a series of parameters is entered at the beginning of a SMS message. The first word in the text message is a configurable keyword specific to the application, e.g. WEATHER, that the invention 100 will recognize and route (internally) to its Application Gateway, then to the external application 40. Any other text that follows will form the parameters specific to the external application 40. Once the subscriber 10 has finished entering the message, the message is sent to the address of carrier's SMSC 30 server to be relayed (via the MSC 20) to the Application Gateway. Note that necessary SMPP routing will need to be configured on the SMSC 30 and the invention 100 enable this functionality.

Continuing with reference to FIG. 1A, the invention's 100 SMTP Gateway application provides bi-direction email transfer to and from any SMS capable mobile terminal. Again, much of the foregoing and ensuing remains quite short-message (SM)-centric (and enhanced SM-centric), and is purely for illustrative purposes as the open architecture nature of the invention of present may apply to messaging network elements in general (as multi-media, instant messaging, tactile ring tones/vibrations/pulses (for the visually impaired), and so forth). Said application enables subscribers 10 to compose emails by entering a system configurable keyword using the SMS originate capability feature of their handsets 10. The SMTP Gateway application also provides additional features such as exception list management and throttling.

Anyone with access to an email client can send email messages to mobile subscribers on the carrier's network by knowing the subscriber's MSIDSN, e.g. 12345678@domain.com. The SMTP Gateway application supports incoming email messages from any SMTP compatible client. Subsequently the SMTP message is converted into SMPP and forwarded to the invention 100 for more sophisticated routing and application management.

Conversely still, there are two methods that a subscriber can originate emails using a SMS enabled handset. One method is to enter a series of parameters at the beginning of the SMS message. The first word in the text message is a configurable keyword (default value is “MAIL”) that the invention 100 will recognize and route to the SMTP Gateway. The second word that appears in the text message is the destination email address. Any other text that follows will form the actual body of the email. For example: “MAIL user_domain.com Don't Forget About The Meeting Today Martha”. The other method that subscribers 10 can use is to set the SMS Message Type setting on their handsets 10 to email. Then the subscriber 10 only needs to enter two parameters in the text message; the destination email address and then message body. Note that this method will need to be supported by the handset and the SMSC 30. Once the subscriber 10 has finished entering the message, the message is sent to the address of the telecommunications carrier's SMSC 30 to be relayed to the invention's 100 SMTP Gateway (not shown but again logically incorporated). Note that necessary SMPP routing will need to be configured on the SMSC 30 and the invention 100 to enable this functionality.

1. An open architecture message routing and management system, designed to facilitate and enable text and/or multi-media messaging between multiple telecommunications network elements.

2. The system of claim 1, where such network elements includes ESMEs, SMSCs, MMSCs, and other such elements which may ordinarily intermediate messaging traffic.

3. The system of claim 1, whereby the invention exists as part of a computer program product, comprising:
a) a computer readable memory medium; and
b) a computer program including the mathematic and programmatic logic required to facilitate the steps, methods and rules as such.

4. The system of claim 3, where the computer program product has been articulated to bind and/or receive bind connections from certain network elements.

5. The system of claim 4, whereby messaging traffic between network elements is directed and routed as per parameters articulated within the computer program product.

6. The system of claim 5, whereby such parameters may also be configured as to block, filter, truncate, or otherwise augment or manipulate the telecommunications messaging traffic as per the network operator's needs (including illicit use of network resources, inter alia).

7. An improved method for message routing and load sharing technologies which allow for enhanced utilization of the SMPP message set.

8. The method of claim 7, which is differentiated from the typical round robin mode, in which traffic has been traditionally load shared across a number of transmitter connections to connected SMSCs, and therefore unable to route subsequent follow-up messages (replace_sm, query_sm, submit_sm with replace, etc.) to the same connection, resulting in ESMEs/LAs not being able to utilize the many commands in the SMPP message set.

9. The method of claim 7, whereby such messages sent over a transmitter bind to a specific destination MSISDN are always routed to the same SMSC in a load-sharing configuration, thereby preventing transparency loss in the SMSC bind, and enables ESMEs to utilize the SMPP primitives that need to be routed to the same connection.

10. The method of claim 9, whereby in addressing load sharing needs, said messages need be shared across the different SMSC by a unique identifier.

11. The method of claim 9, whereby the computer program product load shares messaging traffic based on any number of parameters.

12. The method of claim 11, where such parameters may include the source address of the ESME submitted messages

13. The method of claim 10, whereby messages may be grouped and submitted to a single SMSC based on any number of parameters.

14. The method of claim 13, whereby one of those parameters include source address.

15. The method of claim 13, wherein all messages from a particular source address are grouped to and submitted to a single SMSC.

16. The method of claim 15, whereby the computer program product may perform a one-way hash on the source address and a modulus function on the result to transmit all messages from a single source address to a single route.
